(19) United States
(12) Patent Application Publication
(10) Pub. No.: US 2017/0307423 A1
(43) Pub. Date: Oct. 26, 2017

(54) SYSTEM FOR AUTOMATED MEASUREMENT OF FLUID OUTPUT

(71) Applicant: UroStat LLC, St. Louis, MO (US)

(72) Inventors: Mrinal Pahwa, St. Louis, MO (US); Raphael Chunping Sun, St. Louis, MO (US)

(21) Appl. No.: 15/493,723

(22) Filed: Apr. 21, 2017

Related U.S. Application Data
(60) Provisional application No. 62/326,264, filed on Apr. 22, 2016.

(51) Int. Cl. G01F 1/05; G01G 3/14

(52) U.S. Cl. CPC G01F 1/05; G01G 3/1404

(57) ABSTRACT

A system for automatically measuring and recording when fluid such as urine is introduced to a fluid collection container is provided. The system includes a measuring device that includes a load cell in communication with other various electronic components. The load cell is attached on one end to a fixed object like a hospital bed. At its other end, it is attached to a fluid collection container such as a urine collection bag. When fluid is introduced into the container, the load cell detects a stress change. A strain gauge (or gauges) on the load cell detects a resistance change and reads the change as a voltage change. That voltage change is amplified and digitized and converted to a weight, volume, and flow rate, before being transmitted to a recordkeeping system like electronic medical records. The system thus provides for real time measurement of fluid output collected in the container.

### CROSS-REFERENCE TO RELATED APPLICATIONS

This application claims the benefit of U.S. Provisional Application No. 62/326,264, filed Apr. 22, 2016, which is hereby incorporated by reference in its entirety.

### BACKGROUND OF THE INVENTION

The present invention relates generally to an automated method for measuring fluid output. More particularly, the invention relates to measuring the fluid (for example urine) output using a load cell.

Urine output can be an important metric that guides clinical care for patients that are hospitalized and have a catheter placed in their bladders. Typically, for these patients, urine drains from the catheter through a tube and collects in a container. A nurse or other medical technician then measures the volume of urine produced approximately once an hour. These measurements often indicate to a health care professional the patient's current condition and guide a health care professional to make determinations about what should be done next. The nurse or technician typically uses a graduated cylinder to determine how much urine was produced since the previous measurement. This data may then be manually or electronically entered into the patient's electronic medical record (EMR).

The manual nature of urine output measurement can negatively affect patient care. Visual inspection of the graduated cylinder introduces human error and decreases the accuracy of the measurements. More importantly, the time between measurements can be delayed and occasionally a measurement can be missed altogether because of the many tasks a nurse is responsible for throughout the day associated with a large patient load. Thus, any irregularities in urine output are often detected with delay, and this makes it difficult for patient care providers to prescribe treatments in real-time.

Automated solutions for measuring urine output include using ultrasonic waves to detect the fluid level of the urine collection container and in-line flow meters that measure the amount of urine that flows in the tubing between the catheter and the collection container. These solutions have not been widely adopted due to high costs and limited efficacy.

### SUMMARY OF THE INVENTION

The invention described below aims to measure fluid output automatically and thereafter update a patient's EMR in real-time with frequent and accurate measurements of fluid (such as urine) output so patient care providers will have up-to-date and accessible data to inform their decisions on patient treatment. In a preferred embodiment, a small measuring device is provided that hangs from a fixed point like a patient's bed rail (or elsewhere near a patient) at an upper end. At a lower end of the measuring device, a urine collection container (or other fluid collection container) hangs from the measuring device.

The collection container may be in fluid communication with a patient bladder or other organ by a catheter and tube assembly, as known and understood in the art. Preferably, this is accomplished using hooks, though other attachment means are possible. In a preferred embodiment, the measuring device is constructed using a load cell with thin film strain gauge sensors. The sensors preferably change in resistance as they bend when stresses or strains are detected. Such a stress or strain may be detected when fluid is introduced to the collection container to which the load cell is coupled.

Additionally, the device may include each of an amplifier, a power source, a data transmitter (e.g., Bluetooth, USB port for data transmission, WiFi), an analog to digital converter, and a microprocessor. In a preferred embodiment, when the load cell detects a strain or stress (when fluid is added to the collection container), a resistance change across the load cell is detected, and an associated voltage change is sent from the power source to the load cell. The detected voltage change across the load cell may then be amplified by the amplifier and sent to an analog to digital converter.

The digitized signal is preferably sent to the microprocessor to filter out noise and calculate volume and flow rate. The filtering and calculations may be carried out using software-based algorithms. The algorithm preferably converts the change in weight of the fluid collection container into units of volumes. Preferably, an algorithm also calculates the urine flow rate from the volume measurement. A program that updates a video screen in real-time with the current value for flow rate and regularly update the patient's EMR may also be provided. Additionally, in a preferred embodiment, an algorithm filters any environmental noise, e.g. draining or moving the urine collection container. The algorithms may be embedded within the microprocessor or may exist as a separate component on a computer.

The volume and flow rate values may then be sent in regular intervals via USB or Bluetooth to the EMR to be stored. Other data transmission mediums known or understood to those skilled in the art such as WiFi are also envisioned. The EMR may be hosted on a computer device or remote storage, such as a cloud.

In one embodiment, hardware components of the measuring device may be contained in a single housing and connected to the EMR via USB or Bluetooth. In another embodiment, the hardware of the measurement device is divided between two housings. In that embodiment, the load cell and hooks associated therewith may be contained in a first housing. Electronic and/or data wires may tunnel out from this first housing and connect to the amplifier that is housed in a second housing, along with the power source, microprocessor, analog to digital converter, and Bluetooth or USB transmitter.

### BRIEF DESCRIPTION OF THE DRAWINGS

FIG. 1 is a perspective view of a fluid output measurement system in use in accordance with an embodiment of the present disclosure.

FIG. 2 is an exploded view of a measurement device of the measurement system of FIG. 1.

FIG. 3 is a flow diagram that demonstrates the flow of information through some of the hardware components shown in FIG. 2.

FIG. 4 is a flow diagram that demonstrates how a first embodiment of the fluid output measurement system interfaces with the application environment.

FIG. 5 is a flow diagram that demonstrates how a second embodiment of the fluid output measurement system interfaces with the application environment.

### DETAILED DESCRIPTION OF THE INVENTION

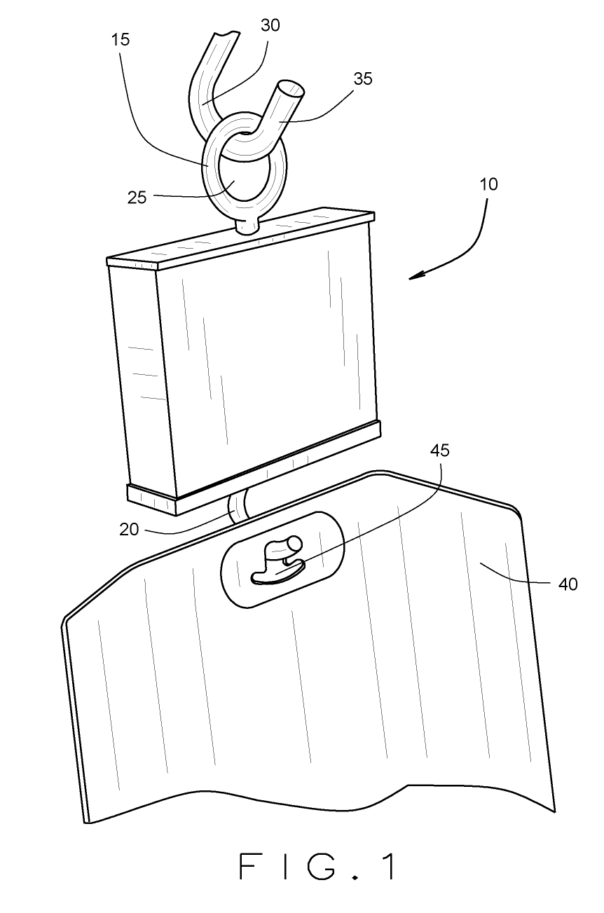

Referring to the drawings more particularly by reference numbers wherein like numbers refer to like parts, FIG. 1 illustrates a fluid output measuring device 10 constructed according to the teachings set forth below. As shown in and illustrated in FIG. 1, the fluid output measuring device 10 may include each of an upper attachment number 15 and a lower attachment member 20. The upper attachment member 15 is shown and illustrated as a circle-shaped hook including an aperture 25 at its center portion. A hook member 30 that may be attached at its upper end (not illustrated) to an existing fixed structure, such as a hospital bed railing, is preferably coupled at a lower end 35 to the upper attachment member 15. The lower attachment member 20 is preferably constructed as a hook-shaped device, as known and understood in the art.

A fluid collection container 40 is preferably in fluid communication with a patient's bladder or other fluid producing organ or body part. For example, the fluid collection container 25 may be a urine collection bag (as illustrated) having a tube (not illustrated) that is in fluid communication with a catheter placed in a patient's bladder (not illustrated, but well understood in the art). As shown in FIG. 1, the fluid collection container 40 preferably includes an aperture 45 that is formed in the fluid collection container 40. The aperture 45 preferably receives the lower attachment member 20, thus coupling the fluid collection container 40 to the measuring device 10 by the lower attachment member 20.

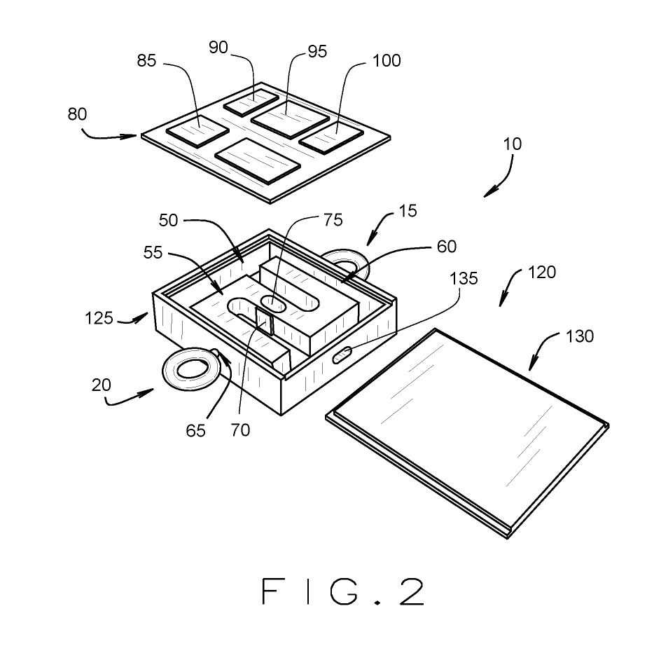

Turning now to FIG. 2, the measuring device 10 and its various components are illustrated in greater detail. As shown in FIG. 2, an interior portion 50 of the measuring device 10 may include a load cell 55 of the type known and understood in the art. The load cell 55 may be a transducer used to create an electrical signal that has a magnitude directly proportional to the force being measured. Several types of load cells may be used within the interior portion 50 of measurement device 10, but in the illustrated embodiment, the load cell 55 is an S-type load cell. An S-type load cell is an S-shaped block that can be used either to measure either compression or tension. The load cell 55 is preferably in communication at an upper end 60 with the upper attachment member 15 and at a lower end 65 with the lower attachment member 20.

A strain gauge 70 is shown and illustrated near a center, hollow portion 75 of the load cell 55. The strain gauge 70 may be of the type commonly known and understood in the art that used to measure strain on an object (in this case the load cell 55). The strain gauge 70 preferably consists of an insulating flexible backing which supports a metallic deformable foil pattern. The strain gauge 70 may be attached to the load cell 55 by a suitable adhesive, such as a cyanoacryoate. When the foil of the load cell 55 is deformed, the electric resistance of the strain gauge 70 changes. The load cell 55 may include up to four strain gauges such as strain gauge 70. Preferably, the strain gauges 70 are arranged as a Wheatstone bridge, an electric circuit configuration commonly in the electrical arts used to measure resistance.

As described above, the center of the load cell 55 may be hollow. This design helps to ensure that a linear output voltage from the load cell 55 is produced as a function of weight.

As set forth above, the load cell 55 is preferably in communication at its upper and lower ends 60, 65 with the attachment members 15, 20, respectively. Thus, when the upper attachment member 15 is in communication with a hook member such as hook 30 (or other fixed point) and the lower attachment member 20 is coupled with a fluid collection container such as fluid collection container 40, a strain may be applied to the load cell 55 when a fluid is introduced to the liquid collection container 40. When this strain occurs, the strain gauge 70 (and any additional strain gauges present on the load cell 55) may detect a change in resistance.

The strain gauge or gauges 70 are preferably in electronic communication with various components of an electronic board 80, which may be embodied as a printed circuit board, or “PCB”. Various commonly known and understood electronic components are preferably mounted on the PCB 80. The illustrated embodiment provides a preferred embodiment, but other known or foreseeable electronic circuit configurations are also envisioned. In those embodiments, the electronic circuit would preferably carry out the methods described herein.

In a preferred embodiment, the illustrated PCB 80 includes each of an amplifier 85, an analog to digital converter 90, a microprocessor 95, a transmission unit 100, and a power source 105. As will be described below, the transmission unit 100 may be a variety of different transmission types including USB or Bluetooth. Similarly, the power source 105 may be a battery, supplied by USB power, or a separate communication such as AC power.

The load cell 55 and the PCB 80 are preferably contained within a housing 120. In at least one alternative embodiment described below, the load cell 55 and strain gauge or gauges 70 may be contained in one housing, while the printed circuit board is contained in a separate housing. In the illustrated embodiment however, the housing 120 that contains each of the load cell 55 (and strain gauge or gauges 70) and the PCB 80 includes each of a base member 125 and a lid member 130. The lid member 130 is preferably releasably attachable to the base member 125 in a known manner, like a friction fit.

The housing 120 may also include a port, or aperture, 135 located in the base member 125. The port 135 may be useful for the embodiment where the load cell 55 and strain gauge or gauges 70 are housed separately from the PCB 80 and where wires may be required to connect the load cell 55 and its strain gauge or strain gauges 70 to the PCB 80 in the manner described below.

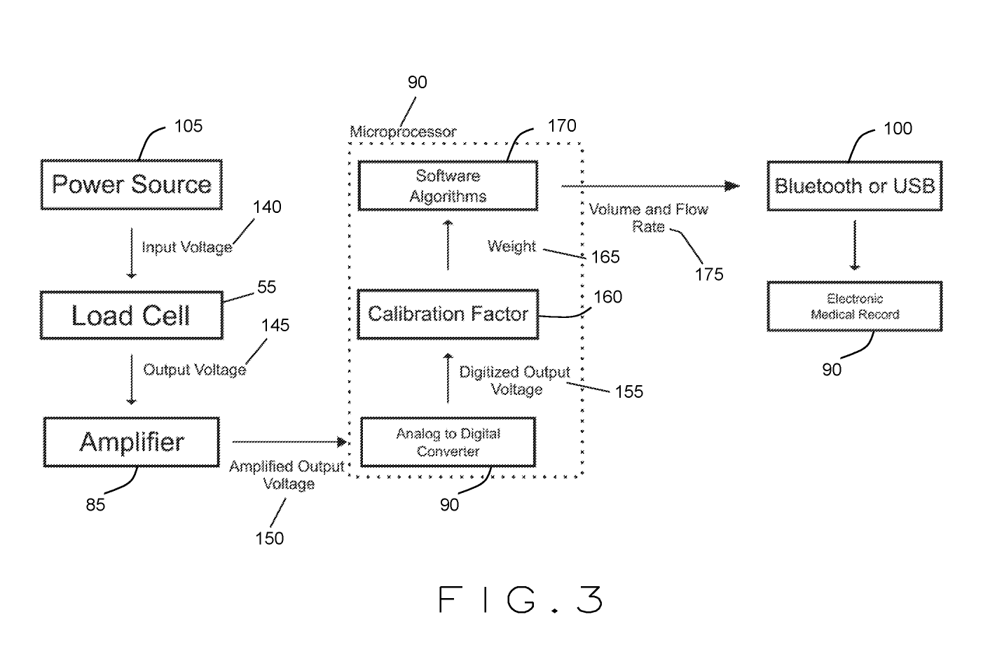

Turning now to FIG. 3, a flow diagram is provided that models the flow of information that preferably occurs for some of the hardware components of the measuring device 10. As shown in FIG. 3, the power source 105 may be responsible for providing an input voltage 140 to the load cell 55 (though via other various electronic communications known and understood in the art, other electronic components within the measuring device 10 may also be powered by the power source 105). The load cell 55, upon detecting a change in its strain from fluid (such as urine) introduced into the fluid collection container 40, preferably causes a resistance change in the strain gauge or gauges 70 of the load cell 55. The load cell 55 may then preferably output an output voltage 145 (associated with the change in resistance in the strain gauge or gauges 70) to the amplifier 85. An amplified output voltage 150, which is output in an analog form, may then be received by the analog digital converter 90. The analog to digital converter 90 preferably outputs a digitized output voltage 155.

A calibration factor 160 may be applied to the digitized output voltage 155 using a factor that is calculated to convert the change in voltage to a change in weight within the liquid collection container 40. A calculated weight 165 may then be subjected to software algorithms 170 that convert the weight calculation 165 to a volume and flow rate 175. The calibration factor 160 and software algorithms 170 may be carried out by the microprocessor 95 in a manner known and understood in the art, substantially similar to other microprocessors.

Data including the volume and flow rate 175 of fluid added to the container 40 may then be sent via the transmission unit 100 (which may be using USB or Bluetooth technology) to an electronic medical record 180 stored on a computing device, as known and understood in the art. That way, a medical professional may be able to retrieve data regarding fluid collecting in the fluid container 40 in real time by monitoring or reviewing the electronic medical record 180.

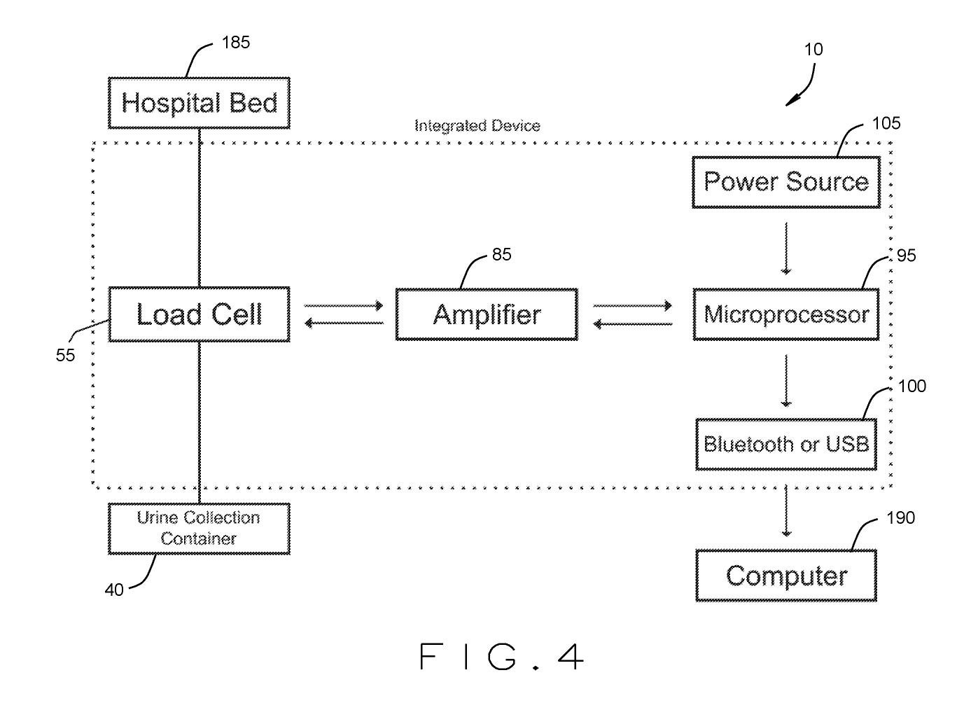

Turning now to FIG. 4, a flow diagram is provided that demonstrates how a first embodiment of the measurement device 10 operates. In that particular embodiment, the various components of the device 10 are housed together in a single housing as shown in FIG. 1. As provided in FIG. 4, the integrated measuring device 10 may be attached at an upper end to a hospital bed 185 and at a lower end to the collection container 40, in this case, a urine collection container 40. The integrated device 10 preferably includes the load cell 55 placed between the hospital bed 185 and the urine collection container 40. In this position, the load cell 55 is preferably able to measure strains or stresses felt in either direction (from the upper end or the lower end), but especially from fluid introduced to the fluid container 40.

As previously set forth, the load cell is then preferably able send an output voltage to the amplifier 85 which amplifies the received voltage and sends the amplified voltage to the microprocessor 95. As mentioned above, the power source 105 may power not only the load cell 55 as shown in FIG. 3, but it also may power the microprocessor 95 (and other electronic components with which it is in electronic communication). As shown and described in FIG. 3, the microprocessor 95 may then preferably send data including the volume and flow rate of fluid (such as urine) added to the urine collection container 40 to a transmission unit 100. That information may then be transmitted to a computer 190 that may be able to subsequently send the information to a data collector and/or aggregator such as the electronic medical record 180 which may be hosted on the computer 190. Alternatively, the electronic medical record 180 may be hosted elsewhere, for example a cloud service or other remote host.

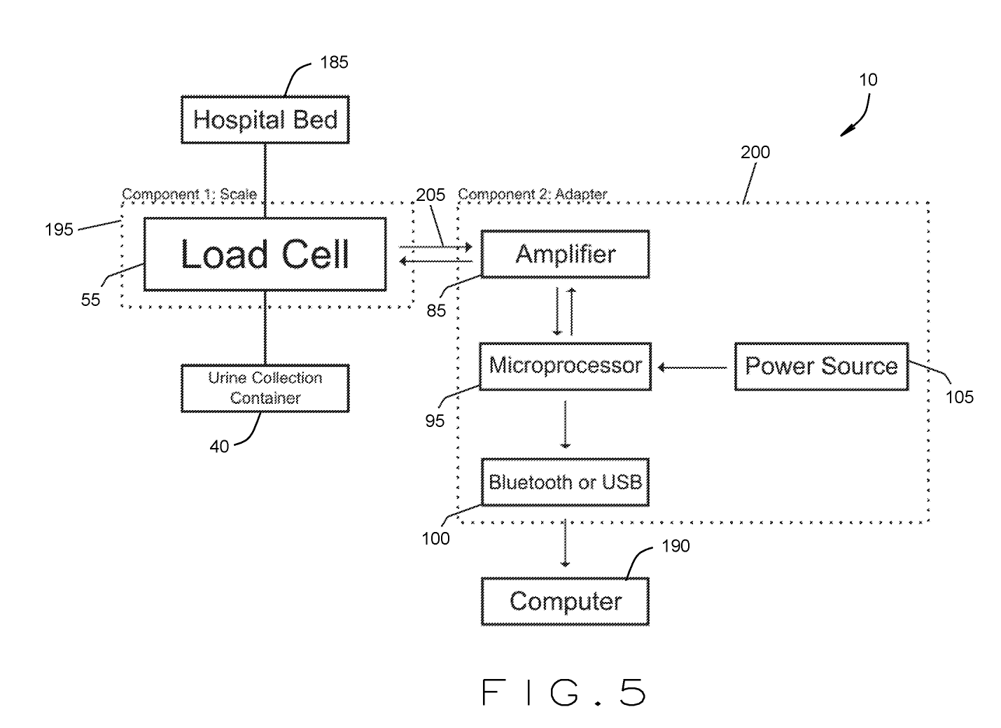

FIG. 5 provides a second alternative embodiment of the measurement device 10 where the load cell 55 (and strain gauge or gauges 70) and the remaining component parts are separately housed. The load cell 55 and strain gauge or gauges 70 are preferably contained in a first housing 195, while the amplifier 85, microprocessor 95 transmission unit 100 and power source 105 are all housed in a second housing 200. Like the diagram shown in FIG. 4, the load cell 55 is preferably secured at its upper end to the hospital bed 185 and at its lower end to the urine collection container 40 so that its able to detect any changes in strains or stresses between the hospital bed 185 and the urine collection container 40 when fluid (such as urine) is added to the collection container 40.

The substantial manner in which measurements are taken and data is output it is substantially similar to the process shown and illustrated in FIG. 4. However, as set forth above, in FIG. 5 the load cell 55 and the remaining components are housed separately. Thus a communication means 205, which may be embodied as a wire or unwired connection, is provided between the two housing 195 and 200 that connects the load cell 55 to the amplifier 85. In the event that the communication means 205 is a wire, the wire may connect the components of the two housings 195, 200 and may be fed through the port 135 shown and illustrated in FIG. 2.

In the embodiment described above, the housing 195 may be formed integrally with the container 40. In other embodiments, the housing 170 may also be integrally formed with the container 40.

Thus, there has been shown and described a system for continuous, automated measurement of fluid output, such as urine. As is evident from the foregoing description, certain aspects of the present inventions are not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. All such changes, modifications, variations and other uses in applications which do not depart from the spirit and scope of the present inventions are deemed to be covered by the inventions which are limited only by the claims which follow.

1. A system for automated measurement of fluid output, the system comprising:
a measurement device, the measurement device comprising:
a load cell;
at least one strain gauge positioned and located on the load cell;
a first attachment member at an upper portion of the load cell for attaching the upper portion of the load cell to a fixed point;
a second attachment member at a lower portion of the load cell for attaching the lower portion of the load cell to a fluid collection container; and
a microprocessor in communication with the at least one strain gauge that receives a voltage of the at least one strain gauge,
wherein when fluid is added to the fluid collection container the voltage across the at least one strain gauge changes, and
the microprocessor calculates at least one of a volume and a flow rate of fluid added to the fluid collection container.

2. The system of claim 1, wherein the load cell is an S-type load cell.

3. The system of claim 1, wherein the system includes four strain gauges arranged as a Wheatstone bridge.

4. The system of claim 1, wherein the system includes an amplifier that amplifies the voltage of the at least one strain gauge before the voltage is received by the microprocessor.

5. The system of claim 1, wherein the system includes an electronic database to which the at least one of a volume and a flow rate is output.

6. The system of claim 5, wherein the electronic database is an electronic medical record hosted on at least one of a computer device and a cloud storage.

7. The system of claim 1, wherein the system includes an analog to digital converter that converts the voltage received from the load cell to a digital signal.

8. The system of claim 1, wherein the system includes a housing in which the load cell is contained.

9. A system for automated measurement of fluid output, the system comprising:
a fluid collection container;
a measurement device, the measurement device comprising:
a load cell;
at least one strain gauge positioned and located on the load cell;
a first attachment member at an upper portion of the load cell for attaching the upper portion of the load cell to a fixed point;
a second attachment member at a lower portion of the load cell for attaching the lower portion of the load cell to the fluid collection container; and
a microprocessor in communication with the at least one strain gauge that receives a voltage of the at least one strain gauge,
wherein when fluid is added to the fluid collection container the voltage across the at least one strain gauge changes, and
the microprocessor calculates at least one of a volume and a flow rate of fluid added to the fluid collection container.

10. The system of claim 9, wherein the load cell is an S-type load cell.

11. The system of claim 9, wherein the system includes four strain gauges arranged as a Wheatstone bridge.

12. The system of claim 9, wherein the system includes an amplifier that amplifies the voltage of the at least one strain gauge before the voltage is received by the microprocessor.

13. The system of claim 9, wherein the system includes an electronic database to which the at least one of a volume and a flow rate is output.

14. The system of claim 13, wherein the electronic database is an electronic medical record hosted on at least one of a computer device and a cloud storage.

15. The system of claim 9, wherein the system includes an analog to digital converter that converts the voltage received from the load cell to a digital signal.

16. The system of claim 9, wherein the system includes a housing in which the load cell is contained.

17. A method for measuring urine output in real time, the method comprising the steps of:
sensing a load change as a voltage change in a load cell that is attached at an upper end to a fixed point and at a lower end to a fluid collection container when fluid is added to the fluid collection container;
outputting the voltage change from the load cell to a microprocessor;
converting the voltage change to a weight change;
converting the weight change to at least one of a volume and a flow rate; and
outputting the at least one of a volume and a flow rate to an electronic medical record hosted on at least one of a computer device and a cloud storage.

18. The method of claim 17, wherein the voltage change is amplified before it is output to the microprocessor.

19. The method of claim 18, wherein the voltage change is digitized by an analog to digital converter before it is converted to a weight change.

20. The method claim 18, wherein the system includes four strain gauges arranged as a Wheatstone bridge.
